(19) United States
(12) Patent Application Publication
(10) Pub. No.: US 2021/0166507 A1
(43) Pub. Date: Jun. 3, 2021

(54) Apparatus And Related Method For Isolation Locking Of An Asset

(71) Applicant: ISOL8 PTY LTD, Guildford (AU)

(72) Inventor: Stephen Craig Power, Ellenbrook (AU)

(21) Appl. No.: 17/047,343

(22) PCT Filed: May 13, 2019
(86) PCT No.: PCT/AU2019/050446

§ 371 Date: Oct. 13, 2020

(30) Foreign Application Priority Data
May 11, 2018 (AU) 2018901620

(51) Int. Cl. G07C 9/00; E05B 41/00; E05B 39/00; E05G 1/00

(52) U.S. Cl. CPC G07C 9/00182; G07C 9/00912; E05G 1/005; E05B 39/00; E05B 41/00

(57) ABSTRACT

Apparatus and related methods for use in isolation locking of an asset are disclosed. In one aspect, an apparatus (205) is disclosed comprising a containment unit (210) configured for storing one or more articles (eg. isolation keys) therein, a communication module (220) configured capable of receiving a signal, and an identifier (222) registered to the apparatus and provided in a form acknowledgeable by a portable device. The apparatus (205) further comprises an operable device (230) associated with the containment unit (210) and configured operable to perform an action in (respect of the containment unit) in response to the signal received by the communication module (220).

### TECHNICAL FIELD

Apparatus and related methods for use in isolation locking of an asset are disclosed.

### BACKGROUND

Typically, when equipment requires maintenance/servicing the equipment is isolated from its electricity and other energy source(s) so that it can be maintained or serviced in a safe manner. The standard way of isolating the equipment is to turn off the energy source supply for the equipment and to physically/mechanically lock the energy supply with an isolation lock. The keys to the isolation lock are then locked away in an isolation lock box so as to prevent other workers from accessing the keys and removing the isolation lock. This process thereby reduces (or avoids) any risk of the energy supply to the equipment being turned on while work is being undertaken. Once maintenance or service work in respect of the equipment has been completed, the isolation lock is removed, allowing the energy supply for the equipment to become available for use.

A problem with such a method is that it is manual and there is no structured recording of ownerships of locks or authorisations/permissions of lock holders. Accordingly, it is against this general background that the embodiments described herein have been developed.

Each document, reference, patent application or patent cited in this text is expressly incorporated herein in their entirety by reference, which means that it should be read and considered by the reader as part of this text. That the document, reference, patent application, or patent cited in this text is not repeated herein is merely for reasons of conciseness.

In this specification, where a literary work, act or item of knowledge (or combinations thereof), is discussed, such reference is not an acknowledgment or admission that any of the information referred to formed part of the common general knowledge as at the priority date of the application. Such information is included only for the purposes of providing context for facilitating an understanding of the inventive concept/principles and the various forms or embodiments in which those inventive

### SUMMARY

According to a first principal aspect, there is provided an apparatus for use in isolation locking of an asset, the apparatus comprising:

a containment unit configured for storing one or more articles required for the operation of the asset, and configured so as to be capable of transitioning to a locked state by way of more than one operable devices, and

an identifier registered to the apparatus and provided in a form acknowledgeable by a portable device.

Embodiments of the apparatus of the first principal aspect may comprise any of the following features.

In one embodiment, the containment unit comprises a storage receptacle comprising a volume within which the or each articles are held for storage purposes (temporary or otherwise).

In another embodiment, the or each article comprises one or more components of a lock assembly, such as for example, a key portion of the lock assembly. The assembly may be an isolation lock which is used to shut off the energy source to the asset. The key portion of the lock assembly is in the storage receptacle and locked in the manner described below so as to prevent prospective workers from inadvertently accessing the keys (without the appropriate authorisations), and allowing the energy supply to be reactivated.

In one embodiment, the portable device is one remote from the apparatus. In one form, the portable device is an electronic device such as, for example, a tablet computer, a smartphone, personal digital assistant, or like electronic device.

The portable device may be associated with an assigned user who may access software running on the device (installed locally or running via a network server) by way of providing an appropriate identification code to the electronic device which acknowledges the user.

In one embodiment, the identifier is provided in the form of indicia that can be interpreted by the electronic device when equipped with the appropriate resources to do so. Such indicia could include visual indicia such as for example, QR codes, bar codes, and the like, where the code is configured so as to identify the asset and/or apparatus to the user of the electronic device.

In another embodiment, the identifier is provided in the form of an electronic tag configured so as to identify the asset and/or apparatus when scanned or read by the electronic device.

In a further embodiment, the electronic tag is located on the outside of the storage receptacle. In another embodiment, the electronic tag is located on the inside of the storage receptacle.

In one embodiment, interpretation of the indicia, scanning, or reading of the electronic tag occurs when the electronic device and the apparatus are in a proximity of each other.

In another embodiment, the electronic device communicates with the electronic tag using near field communication (NFC) or other like wireless communication protocols/technology.

In one broad form, the or each operable device is configured operable to facilitate a locking or unlocking operation in respect of the apparatus. In this manner, the operable device may be operated so as to place the apparatus in a locked or unlocked state.

In a further embodiment, the storage receptacle comprises a lip portion located on the outside of the storage receptacle and arranged operable with a closure of the storage receptacle for the purposes of transitioning the containment unit to the unlocked or locked state.

In one embodiment, the lip portion and the closure comprise more than one corresponding apertures configured for receiving a portion of the operable device.

In one form, the or each operable device is a physical lock configured so as to engage the apertures of the lip portion and the lid for the purposes locking them in a proximal relationship, thereby placing the containment unit into a locked state and denying access to the contents of the storage receptacle.

In another embodiment, the or each operable device is a padlock serving to provide a physical locking of the containment unit.

In a further embodiment, the apparatus is secured to a base so as to prevent relocation from a worksite at which the containment means is located.

In one embodiment, the apparatus comprises a handle portion.

According to a second principal aspect, there is provided a method for isolation locking of an asset, the method comprising:

identifying a containment apparatus associated with the asset,

acknowledging a first user,

admitting for containment by the containment apparatus one or more articles required for operation of the asset,

operating a first operable device associated with the first user to a state in which the containment apparatus is locked,

acknowledging that the containment apparatus is in a locked state by way of the first user,

acknowledging a second user,

determining whether the second user has authorisation to undertake an action in respect of the asset,

if so authorised, operating the second operable device to a state in which the containment apparatus is locked, and

acknowledging that the containment apparatus is in a locked state by way of the second user thereby isolation locking the asset.

Embodiments of the method of the second principal aspect may comprise any of the following features.

In one embodiment, the containment apparatus is any embodiment of an apparatus of the first principal aspect.

In another embodiment, the method involves identifying the asset (for example, a piece of equipment requiring electrical isolation). In one embodiment, such an identification step is performed by way of the electronic device of the first or second user acknowledging the identifier of the relevant containment apparatus.

The method may comprise verifying that the containment apparatus the electronic device is approximate to, is the correct containment apparatus for the asset. Such verification may be performed by the electronic device associated with the first and/or second user once acknowledging the identifier of the containment apparatus.

In one embodiment, the first and second operable devices are first and second locking devices respectively. In one form, the first and second locking devices are physical locks, such as for example, padlocks.

In one embodiment, the first locking device is a locking device registered to the first user, and the second locking device is a locking device registered to the second user.

In another embodiment, the first user is assigned an electronic device, and the second user is assigned an electronic device.

In one embodiment, acknowledging the first and second users is by way of a portable device, such as for example, an electronic device as described above.

In a further embodiment, acknowledgement of the first user is by way of the first user ‘signing in’ via their electronic device using an identification code registered to the first user.

In one embodiment, the first user is one issued appropriate authorisation(s) required for isolating the asset in order for one or more actions or activities to be undertaken in respect of the asset (for example, an Isolation Officer) by one or more workers authorised to undertake such actions or activities.

In another embodiment, the method comprises placing the article (eg. isolation key) required for the operation of the asset (under care of the first user) inside a storage receptacle of the containment apparatus.

In one form, the method involves the first user scanning an electronic tag provided on their respective locking device by way of their electronic device, this acknowledging that the first user has or will place their locking device on the containment apparatus.

In one embodiment, the first user then attends to locking the containment apparatus by way of their assigned physical locking device (such as for example, a padlock).

In one embodiment, the first and second locking device comprise an identifier which corresponds to the first and second users respectively. Such identifiers may be provided in the same form as the identifier described above in relation to the apparatus of the first principal aspect.

In one form, the second user scans an electronic tag provided on their respective locking device by way of their electronic device, this acknowledging that the second user intends to or has placed their locking device on the containment apparatus.

Once the containment apparatus is locked, the method comprises acknowledging that the relevant isolation is complete. In one implementation, acknowledgment of such is carried out by way of the first user notifying (eg. electronically) a person having the required authorisations (such as for example, a supervisor of the Isolation Officer) that the isolation is complete. In this manner, a worker tasked with undertaking one or more actions or activities in respect of the asset can now secure their own locking device (eg. padlock) to the containment apparatus.

In another embodiment, acknowledging the second user is performed by way of a substantially similar process as with the acknowledgement of the first user. Thus, acknowledgment of the second user (such as, for example, a worker to undertake an action or activity in respect of the asset) comprises the second user ‘signing in’ to their respective electronic device using their assigned identification code.

In one embodiment, determining whether the second user has authorisation to undertake an action in respect of the asset is by way of the electronic device associated with the second user. This determination is, in practice, made by way of reference to a relevant isolation plan or protocol (hereinafter, Isolation Plan) that has been prepared for the relevant asset and downloaded (from, for example, a relevant computer network) to the second user's assigned electronic device. In this regard, once the electronic device of the second user identifies the apparatus and/or asset, the electronic device queries the download Isolation Plan so as to determine whether the second user has the appropriate permissions/authorisations to undertake action(s) in respect of the asset.

Once such verification returns affirmative, the second user acknowledges via their electronic device that they have or are placing their locking device on the containment apparatus.

In one form, acknowledging that the containment apparatus is in a locked state by way of the second user involves the second user acknowledging via their electronic device that they have placed their locking device (ie. physical padlock) on the containment apparatus.

In one embodiment, the method further comprises authorising the second user to undertake an action in respect of the asset by way of the second user receiving a notification (message) on their electronic device.

According to a third principal aspect, there is provided an apparatus for use in isolation locking of an asset, the apparatus comprising:

a containment unit configured for storing one or more articles required for the operation of the asset,

a communication module configured to be capable of receiving a signal,

an identifier registered to the apparatus and provided in a form acknowledgeable by a portable device, and

an operable device associated with the containment unit and configured operable to transition the containment unit to a locked state in response to a signal being received by the communication module.

Embodiments of the apparatus of the third principal aspect may comprise any of the following features.

Embodiments of the apparatus of the present aspect may incorporate any of the features described above in relation to the apparatus of the first principal aspect.

In one embodiment, the first and second operable devices of the apparatus of the present aspect are configured operable for, broadly, performing a locking operation in respect of the containment apparatus. In one broad form, the first operable device of the present aspect is configured operable to facilitate a locking or unlocking operation by electronic means. In one embodiment, the first operable device is an electronic lock operable by way of electronic circuitry (eg. such as for example, a controller) arranged to control (between unlocked and locked states) a physical element such as a solenoid (for example). In this manner, a storage receptacle of the containment apparatus can be placed into locked and unlocked states.

In one embodiment, the operable device comprises electronic circuitry configured so as to cause one or more actions to be performed in response to the signal being received from a portable device (eg. an electronic device as described above). Such actions may comprise any of the following: an unlocking operation in which the containment unit transitions from a locked state to an unlocked state, a locking operation in which the containment unit transitions from an unlocked state to a locked state.

In another embodiment, the communication module is operable with a controller of the operable device so as to relay commands thereto for controlling the operable device on receipt of signals from the electronic device.

In a further embodiment, the communication module may be configured capable of two-way (TX/RX) communication with the (portable) electronic device. Such communication may utilise any wireless protocols as appropriate.

According to a fourth principal aspect, there is provided a method for isolation locking of an asset, the method comprising:
identifying a containment apparatus associated with the asset, the containment apparatus configured operable between unlocked and locked states by way of, at least in part, an operable device of the containment apparatus,
acknowledging a first user,
requesting an unlocked state of the containment apparatus, p1 admitting for containment by the containment apparatus one or more articles required for operation of the asset when the containment apparatus is in an unlocked state,
operating the operable device so as to provide the containment apparatus in a locked state,
acknowledging that the containment apparatus is in a first locked state by way of the first user,
acknowledging a second user,
determining whether the second user has authorisation to undertake an action in respect of the asset,
if so authorised, registering a request to associate a second locked state of the containment apparatus by the second user,
if so accepted, registering the second locked state of the containment apparatus thereby isolation locking the asset.

Embodiments of the method of the fourth principal aspect may comprise any of the following features.

Embodiments of the method of the present aspect may incorporate any of the features described above in relation to the method of the second principal aspect. Accordingly, the skilled reader will understand the features of the second principal aspect that are relevant to the method of the present aspect.

In one embodiment, the containment apparatus comprises any embodiment of an apparatus of the third principal aspect.

In one embodiment, acknowledgement of the first and second users is as described above, ie. each user ‘signing in’ via their respective portable devices (eg. the electronic devices having, for example, relevant software installed thereon).

In one embodiment, a request is made by the first user for the containment apparatus to be placed in an unlocked state via their personal electronic device once they have completed the ‘signing in’ process. If no locked states are registered by the electronic device following the first user's request, the electronic device will transmit a signal which places the containment apparatus in an unlocked state, following which, the first user will be permitted to admit the relevant article(s) (eg. isolation key) for storage.

In one embodiment, the first user acknowledges via their electronic device that the key(s) have been placed inside the containment apparatus.

In another embodiment, if the containment apparatus is, at the time of the request by the first user, in a locked state, then all locking devices (electronic or otherwise (including ‘virtual’ locks)) will be requested to be removed (to be actioned by their respective users). Embodiments of methods facilitating use of an asset subject to an isolation locking protocol (described in relation to the fifth aspect below) may be carried out in order to allow the containment apparatus to transition to an unlocked state.

In one embodiment, the operable device comprises an electronic lock, substantially as described above in relation to the apparatus of the third principal aspect.

In another embodiment, the electronic lock is configured so as to operate automatically following expiry of a predetermined period of time (eg. 2 seconds in one implementation). In this manner, once the period of time has expired, the electronic lock transitions to a locked state thereby locking the containment apparatus and securing the key(s) therein.

In one form, the period of time commences when a closure of a storage receptacle of the containment apparatus is closed by the first user following admission of the key(s).

In one embodiment, locking of the containment apparatus triggers transmission of a signal from the containment apparatus to the first user's electronic device confirming electronic locking, the electronic device thereby registering (via, for example, relevant software installed on the electronic device) that the containment apparatus is in the locked state by the first user.

Acknowledgement that the containment apparatus is in a first locked state by way of the first user, in one implementation, comprises the first user registering same via their electronic device. In this manner, the electronic device then records or registers (via, for example, relevant software installed on the electronic device) that the containment apparatus has been locked by the first user.

In one embodiment, following the closure of the containment apparatus automatically locking, the first user tests, by physical means or otherwise, that the containment apparatus is indeed locked (electronically or otherwise) and acknowledges same via their electronic device.

Acknowledgement that the containment apparatus is in a first locked state by way of the first user, in one implementation, comprises the step of the first user sending or transmitting a notification confirming that the containment apparatus is in a locked state. For example, such notification may be directed to a person having appropriate authority to receive such a notification, such as, for example, a superior of the first user. This signifies that the second user may now attend to registering a respective second locked state in respect of the containment apparatus (if appropriately authorised).

In one embodiment, while the electronic lock establishes the necessary physical locking of the containment apparatus, the second locked state refers to a locking arrangement that is ‘virtual’ in nature, or not of a purely physical or tangible sense. In this regard, such a virtual lock is, in one form, operably linked to the electronic lock but registered by way of an appropriate software registration whereby the second locked state is registered on their behalf in the electronic device and/or the containment apparatus. In this manner, a record is created that associates a locked state of the containment apparatus in favour of the second user. As a consequence of acceptance of the request made by the second user, the second user's electronic device communicates with the containment apparatus authorising a second locked state in respect of the second user. This information could also be communicated to a centralised computer network.

Communication between the electronic device and the containment apparatus may be facilitated by way of a communication module associated with the containment apparatus which allows for single or dual way (TX/RX) communications with the respective electronic devices.

The method may involve the second user testing, by physical means, that the containment apparatus is indeed locked (electronically or otherwise) and acknowledging same via their electronic device. Such testing may occur at any stage during the process, and by either the first or second users.

The method may comprise notifying the second user that they are authorised to undertake the necessary actions or activities in respect of the asset. For example, this could be exemplified by way of the second user being notified by way of a message received via their electronic device that work can commence on the (now isolated) asset.

According to a fifth principal aspect, there is provided a method for facilitating use of an asset subject to an isolation locking protocol, the asset being in an isolation locked state whereby an article required for operation of the asset is inaccessible by way of a containment apparatus configured for storing the article by way of a first state of the containment apparatus, the method comprising:

requesting one or more first users each having a first state registered in respect of the containment apparatus each perform an action causing respective first states in respect of the containment apparatus be unregistered or deactivated, and

on determining that the or each respective first states are unregistered or deactivated, authorising a second user to perform an action, which, when completed, allows access to the article.

In one embodiment, the isolation locking protocol is any embodiment of a method described herein for isolation locking of an asset.

In a further embodiment, the first state is a state in which the containment apparatus is locked. The first state is established by way of an operable device, which could be a locking device configured of electronic, virtual, or physical/mechanical form.

In one embodiment, the second user is one having higher permissions, privileges or authorisations in respect of the isolation locking of the asset than the first users. For example, the first user may comprise a worker tasked to undertake one or more actions or activities in respect of the asset, and the second user may comprise an authorisation commensurate with, for example, an Isolation Officer tasked with performing high level isolation locking of the asset.

In another embodiment, the action performed by the second user is one facilitating or causing a locking function to operate the containment apparatus to an unlocked state. In this manner, the containment apparatus transitions to an unlocked state thereby allowing the article(s) to be physically accessed.

In a further embodiment, the action performed by the second user is to operate (via, for example, a command via the second user's electronic device) an electronic lock to an unlocked condition to which only the second user has permission to operate. In this manner, the containment apparatus is placed in an unlocked condition allowing the article(s) to now be accessed.

In one embodiment, the method comprises a step of submitting a stored command specific to a first user to remove an electronic lock registered in respect of the containment apparatus.

In another embodiment, the method comprises monitoring and/or waiting for the or each first user to remove their respective electronic locks. In a further embodiment, the method comprises verifying that all electronic locks have been removed.

According to a sixth principal aspect, there is provided a system for use in isolation locking of an asset, the system comprising:

a containment apparatus associated with the asset, the containment apparatus comprising:
a containment unit configured for storing one or more articles required for the operation of the asset, and configured so as to be capable of transitioning to a locked state by way of more than one operable devices, and
an identifier registered to the apparatus and provided in a form acknowledgeable by a portable electronic device.

According to a seventh principal aspect, there is provided a system for use in isolation locking of an asset, the system comprising:
a containment apparatus associated with the asset, the containment apparatus comprising:
   a containment unit configured for storing one or more articles required for the operation of the asset,
   an identifier registered to the apparatus and provided in a form acknowledgeable by one or more portable electronic devices,
   a communication module configured so as to be capable of communicating with one or more portable electronic devices, and
   an operable device associated with the containment unit and configured operable to transition the containment unit between unlocked and locked states in response to a signal being received by the communication module.

In one embodiment, the systems of the sixth or seventh principal aspects may comprise at least one electronic device as described herein, each electronic device associated with a user and, in the case of the seventh aspect, configured so as to be communicable with the communication module of the containment apparatus and/or with a network as described herein.

In one embodiment, the containment apparatus of the system of the sixth aspect is any embodiment of the apparatus of the first aspect, or as described herein.

In another embodiment, the containment apparatus of the system of the seventh aspect is any embodiment of the apparatus of the third aspect, or as described herein.

In another principal aspect, there is provided a method of isolation locking of an asset using any embodiment/implementation of the method of the second principal aspect using any embodiment of the system of the sixth principal aspect.

In a further principal aspect, there is provided a method of isolation locking of an asset using any embodiment/implementation of the method of the fourth principal aspect using any embodiment of the system of the seventh principal aspect.

According to a further principal aspect there is provided a storage medium embodying computer executable instructions for controlling a processor of a computing device to perform one or more of the methods described herein.

Various principal aspects described herein can be practiced alone or combination with one or more of the other principal aspects, as will be readily appreciated by those skilled in the relevant art. The various principal aspects can optionally be provided in combination with one or more of the optional features described in relation to the other principal aspects. Furthermore, optional features described in relation to one example (or embodiment) can optionally be combined alone or together with other features in different examples or embodiments.

For the purposes of summarising the principal aspects, certain aspects, advantages and novel features have been described herein above. It is to be understood, however, that not necessarily all such advantages may be achieved in accordance with any particular embodiment or carried out in a manner that achieves or optimises one advantage or group of advantages as taught herein without necessarily achieving other advantages as may be taught or suggested herein.

### BRIEF DESCRIPTION OF THE DRAWINGS

Further features of the inventive principles are more fully described in the following description of several non-limiting embodiments thereof. This description is included solely for the purposes of exemplifying the inventive principles. It should not be understood as a restriction on the broad summary, disclosure or description as set out above. The description will be made (by way of example only) with reference to the accompanying drawings in which:

FIG. 1 shows a schematic view of one embodiment of an apparatus arranged in accordance with the principles disclosed herein;

FIG. 2 shows a flow diagram of another embodiment of an apparatus arranged in accordance with the principles disclosed herein;

FIG. 3 shows a schematic view of one embodiment of a method arranged in accordance with the principles disclosed herein;

FIG. 4 shows a flow diagram of another embodiment of a method arranged in accordance with the principles disclosed herein;

FIG. 5 shows a flow diagram of another embodiment of a method arranged in accordance with the principles disclosed herein; and

FIG. 6 shows a schematic diagram of the operation of one or more embodiments of the present invention.

In the figures, like elements are referred to by like numerals throughout the views provided. The skilled reader will appreciate that elements in the figures are illustrated for simplicity and clarity and have not necessarily been drawn to scale. For example, the dimensions and/or relative positioning of some of the elements in the figures may be exaggerated relative to other elements to facilitate an understanding of the various embodiments exemplifying the principles described herein. Also, common but well understood elements that are useful or necessary in a commercially feasible embodiment are often not depicted in order to provide a less obstructed view of these various embodiments. It will also be understood that the terms and expressions used herein adopt the ordinary meaning as is accorded to such terms and expressions with respect to their corresponding respective areas of inquiry and study except where specific meanings have otherwise been set forth herein.

It should be noted that the figures are schematic only and the location and disposition of the components can vary according to the particular arrangements of the embodiment(s) as well as of the particular applications of such embodiment(s).

Embodiments described herein may include one or more range of values (eg. size, displacement and field strength etc). A range of values will be understood to include all values within the range, including the values defining the range, and values adjacent to the range which lead to the same or substantially the same outcome as the values immediately adjacent to that value which defines the boundary to the range.

Other definitions for selected terms used herein may be found within the detailed description and apply throughout. Unless otherwise defined, all other scientific and technical terms used herein have the same meaning as commonly understood to one of ordinary skill in the art to which the embodiment(s) relate.

### DETAILED DESCRIPTION

The words used in the specification are words of description rather than limitation, and it is to be understood that various changes may be made without departing from the spirit and scope of any aspect of the invention. Those skilled in the art will readily appreciate that a wide variety of modifications, alterations, and combinations can be made with respect to the above described embodiments without departing from the spirit and scope of any aspect of the invention, and that such modifications, alterations, and combinations are to be viewed as falling within the ambit of the inventive concept.

Throughout the specification and the claims that follow, unless the context requires otherwise, the word “comprise” or variations such as “comprises” or “comprising”, will be understood to imply the inclusion of a stated integer or group of integers but not the exclusion of any other integer or group of integers.

Furthermore, throughout the specification and the claims that follow, unless the context requires otherwise, the word “include” or variations such as “includes” or “including”, will be understood to imply the inclusion of a stated integer or group of integers but not the exclusion of any other integer or group of integers.

When an asset, such as for example, electrically powered equipment requires maintenance or servicing, the asset is isolated from its electricity source(s) so that the required work can be carried out in a safe manner. The standard way of isolating such an asset is to isolate its power supply and to physically/mechanically prevent the power supply being reactivated by way of an isolation lock. The key(s) to such an isolation lock is/are then locked away in an isolation lock box so as to prevent prospective workers from accessing the keys and, inadvertently, removing the isolation lock, and allowing the power supply to be reactivated. This isolation locking process seeks to reduce (with the view to ultimately avoiding) any risk of the power supply to the asset being turned on while work is being undertaken. Once maintenance or service work has been completed, the isolation lock is removed, thereby permitting the supply of electricity to the asset for operation as appropriate.

### First Example Embodiment of Containment Apparatus

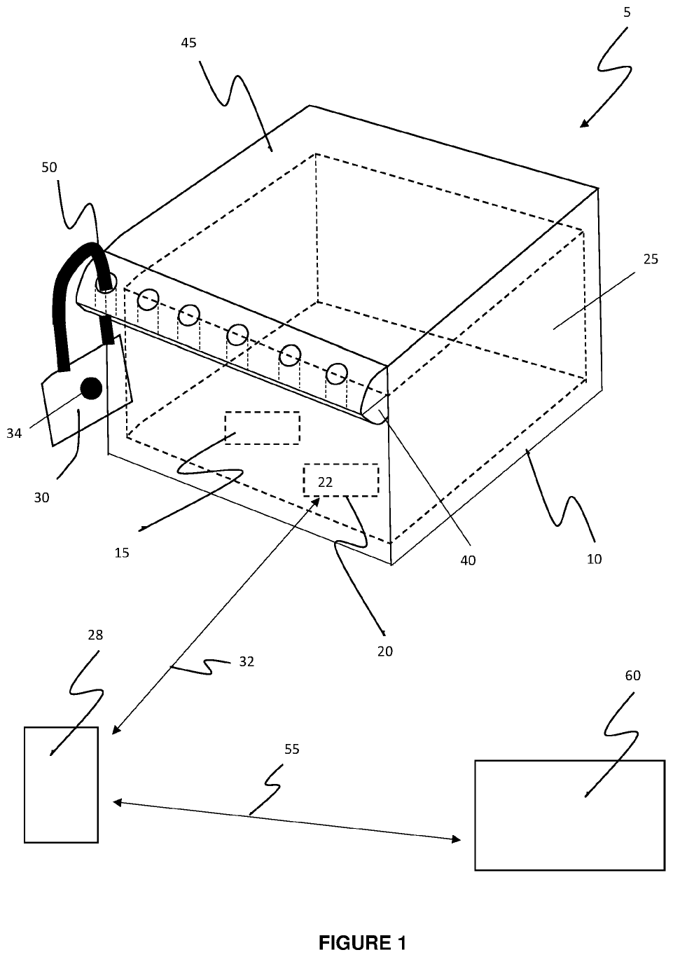

FIG. 1 shows one embodiment of an apparatus 5 for use as an ‘isolation lock box’ for assisting in the isolation locking of an asset, such as, for example, an electrically powered piece of equipment. The apparatus 5 comprises a containment unit 10 configured for storing one or more articles (key 15 shown), and is configured to be lockable by way of operable devices provided in the form of padlocks 30 (one shown in FIG. 1). The apparatus 5 comprises an identifier 22 associated therewith which is registered to the apparatus and provided in a form which can be acknowledgeable by a portable device (such as for example, a tablet computer) so that the apparatus 5 can be identified.

The containment unit 10 comprises a storage receptacle 25 within which the key 15 may be held for storage purposes (temporary or otherwise). Once the key 15 has been used to deactivate the supply of electrical power to the asset, rendering the asset electrically isolated, it is placed in the storage receptacle 25 and the containment unit 10 physically locked in the manner described herein thereby serving as a controlled environment so that the key cannot be used to activate the supply of power to the asset without appropriate authorisation(s). The key may be used to operate a switch which isolates energy from being provided to the asset, or it may be used to unlock an isolation lock (such as for example a padlock) installed on the asset in a manner that isolates energy being provided to the asset.

The containment unit 10 comprises an attachment portion, such as in the form of a lip portion 40, located externally thereof and configured operable with a closure 45. The lip portion 40 and the closure 45 comprise a number of corresponding slots 50, each configured for receiving a respective padlock 30. Thus, the containment unit 10 is configured so that it is mechanically lockable by way of the lip portion 40 and closure 45 both receiving a padlock 30.

The form of the identifier which can be acknowledged by the electronic device 28 may utilise, for example, an electronic tag 22 located either on the inside or the outside of the storage receptacle 25 (location on the inside shown in FIG. 1). The electronic tag 22 is configured so as to be acknowledged by the electronic device 28 when in proximity therewith. For the embodiment shown, the portable device is an electronic device 28 such as, for example, a tablet computer but could be a smartphone, personal digital assistant, or like electronic device. The electronic device 28 communicates 32 with the electronic tag 22 by way of near field communication (NFC). Other wireless technologies could be used.

The apparatus 5 is configured operable such that, when the electronic device 28 is in proximity to the electronic tag 22, the electronic tag is scanned by a reader or like sensing/scanning device operable with the electronic device.

This acknowledgement registers the identifier 22 with the electronic device 28 which then operates to query internally available data (which may be downloaded from an overarching network) and confirm the identity of the apparatus 5 for an isolation locking task (in respect of the asset to be worked on). Thus, on receipt of the identifier 22, the electronic device 28 performs appropriate verification operations (by way of suitable programming instructions, electronic circuitry or the like) for interrogating the identity of the asset to ensure accuracy of the tasks to be performed, and/or one or more characteristics of a user associated with the electronic device 28, such as for example, whether the user has the required authorisations to undertake work in respect of the asset. It will be understood that the electronic device 28 comprises suitable electronic processing capabilities in order to communicate 55 with an overarching network 60 or system (directly or indirectly) in order to make the necessary interrogations/verifications as might be required. Such electronic processing capabilities of the electronic device 28 involves a processor which may include one or more cores that may enhance speed and performance of a multiprocessor. In embodiments, the process may be a dual core processor, quad core processors, other chip-level multiprocessor and the like that combine two or more independent cores. Indeed, the electronic tag 22 may also be configured having a processor and conferred suitable electronic processing capabilities (and/or communication capabilities) in order to carry out any number of operations as could be required.

Communication 55 between the electronic device 28 and the network 60 is two way. Furthermore, communication between the electronic tag 22 and the electronic device 28 may also be two way. It will also be appreciated that the electronic tag 22 could also be configured so as to be in communication (eg. single or two-way) with the network 60. The network 60 may comprise a server providing an interface to other devices including, without limitation, clients, other servers, printers, database servers, print servers, file servers, communication servers, distributed servers, social networks, and the like. Additionally, this coupling and/or connection may facilitate remote execution of one or more programs across the network 60. The networking of some or all of these devices may facilitate parallel processing of a program or method at one or more locations without deviating from the scope of this disclosure. In addition, any of the devices attached to the server through an interface may include at least one storage medium capable of storing methods, programs, code and/or instructions. A central repository may provide program instructions to be executed on different electronic devices. In such an implementation, the remote repository may act as a storage medium for program code, instructions, and programs.

In practice, the apparatus 5 is securable to a base (not shown) so as to prevent relocation from a worksite where the apparatus is installed.

### First Example Method

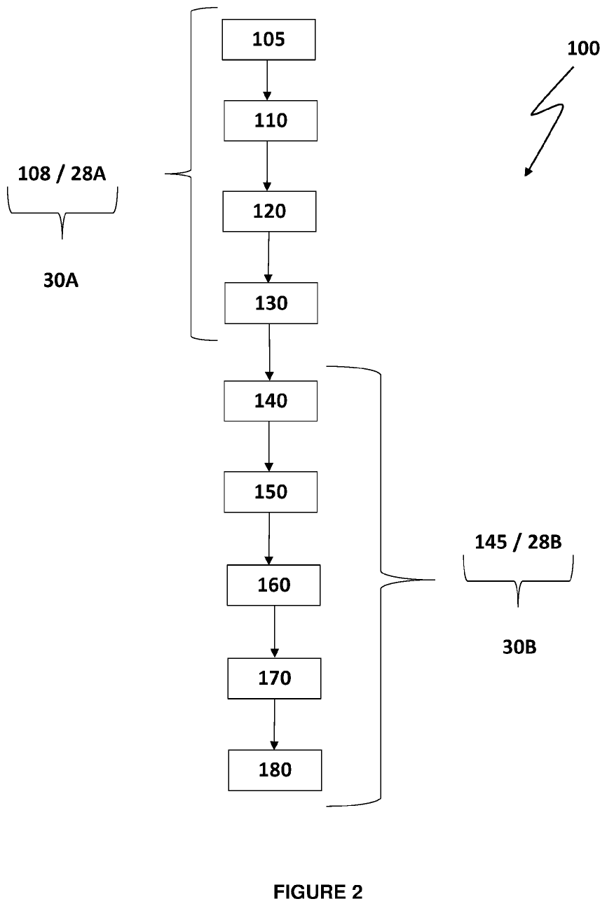

FIG. 2 shows a schematic flow chart of an embodiment of a method 100 for isolation locking of an asset using the apparatus 5. Broadly, the method 100 comprises identifying 105 a containment apparatus (5) that is associated with an asset that is to be isolated. This process involves acknowledging the identifier 22 of the containment apparatus 5 via an electronic device 28 (by way of appropriate wireless technology such as NFC as described above), usually by way of a first user 108.

The method 100 involves acknowledgement 105 of a first user 108 who, in practice, will have the appropriate authorisations for isolating the asset (for example, in some organisations, such a role is performed by an Isolation Officer). Acknowledgement of the first user 108 is by way of the first user ‘signing in’ via their personal electronic device 28A.

With the apparatus (5) in an unlocked state, the first user admits 120 the isolation key(s) in the storage receptacle 25 for secured containment. The method 100 then involves the first user 108 attending to applying 130 their padlock 30A to the containment apparatus 5 in a manner which ensures that the containment apparatus is physically locked.

Acknowledgement 140 that the first user's 108 padlock 30A has been assigned to the apparatus 5 is made via the first user scanning (using NFC technology or other equivalent wireless protocols) an identifier 34 on their padlock 30 into their electronic device 28A thereby signalling that the apparatus 5 is in a locked state. This acknowledgement also includes the first user 108 reporting via their electronic device 28A that the relevant isolation(s) is/are complete by way of notifying (electronically) a person having the required authorisations (such as for example, a supervisor) that the isolation(s) is/are complete. In this manner, a worker (145) tasked with undertaking one or more actions or activities in respect of the asset can now seek to place their respective padlocks (30B) to the containment apparatus 5 so as to carry out tasked work on the asset.

The method 100 further involves acknowledgement 150 of a second user 145, who, in practice, is a worker tasked with undertaking work in respect of the asset. As before, acknowledgment of the worker is by way of a ‘signing in’ process completed by way of the worker's own electronic device 28B. A determination 160 is made as to whether the second user 145 has authorisation to undertake any work in respect of the asset. This determination is, in practice, made by way of reference to a relevant isolation plan or protocol (hereinafter, Isolation Plan) that has been prepared for the relevant asset. Such verification occurs by the electronic device 28B seeking to verify that the second user 145 has the appropriate authorisations to undertake work in respect of the asset.

Upon determination that the second worker 145 has the necessary authorisations to carry out work on the asset, the worker applies 170 their padlock 30B to the apparatus 5 in a manner which ensures that the apparatus 5 is locked by way of the worker's padlock 30B. The worker 145 then acknowledges 180 this development by scanning (using NFC technology or other equivalent wireless protocols) an identifier 34 on their padlock 30B into their electronic device 28B signalling that they have placed their padlock on the apparatus 5. The worker 145 is then notified by a message via the worker's electronic device 28B that they can commence work in respect of the (now appropriately isolated) asset.

It will be appreciated that the progress (or requisite prompts or instructions) of any stage of method 100 can be displayed to the first 108 second 145 via their electronic devices 28A/B.

### Second Example Embodiment of Containment Apparatus

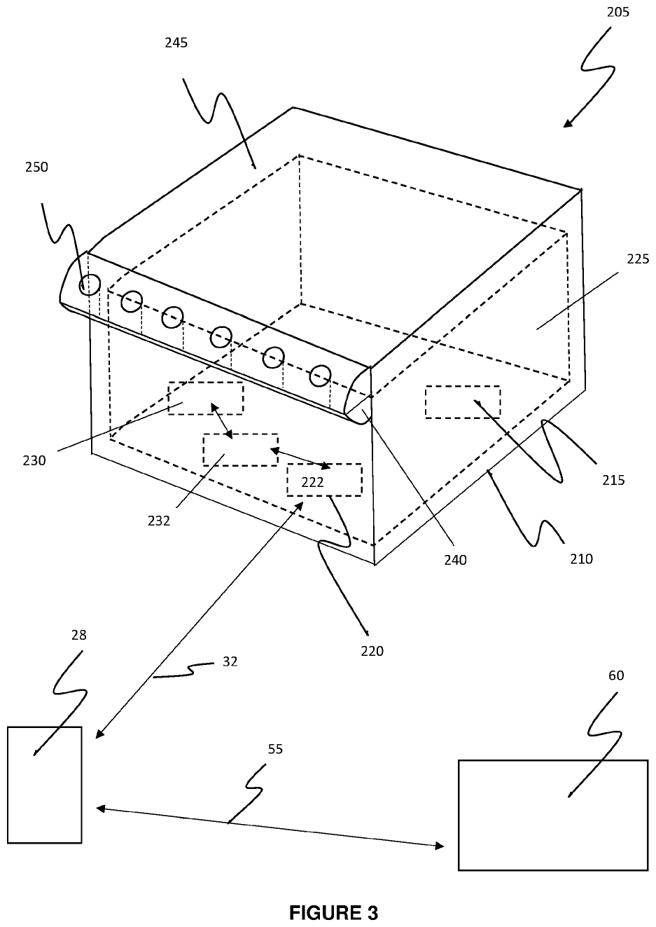

FIG. 3 shows an embodiment of an apparatus 205 also for use in isolation locking of a relevant asset. The apparatus 205 comprises a containment unit 210 configured for storing one or more keys 215 of an isolation lock for an asset. Substantially all of the features of the apparatus 5 are also incorporated in the apparatus 205, such as: identifier 222 (for identifying the apparatus 205 to an electronic device 28), closure 245, storage receptacle 225, lip portion 240, electronic tag 222, apertures 250 for unlocking/locking by way of padlocks if required.

The apparatus 205 comprises a communication module 220 which is configured so as to be capable of receiving a signal (for example, from a portable electronic device 28). As with the embodiment described above, the apparatus 205 comprises an identifier 222 registered to the apparatus and provided in a form that can be acknowledged by the portable device. The apparatus 205 further comprises an operable device 230 associated with the containment unit 210 and configured operable to perform an unlocking/locking action via a controller 232 in respect of the containment unit in response to the signal received by the communication module 220. The apparatus 205 remains configured with lip portion 240, closure 245, and apertures 250 so that physical locking devices such as padlocks (ie. those of the first/second users) can still be applied for locking the containment unit 210.

The operable device 230 is an electronic lock (for example, operable by way of a solenoid) operable by way of electronic circuitry and configured operable to facilitate a locking or unlocking operation of the containment unit 210. The action performed by the electronic lock in response to the signal received from the electronic device involves, for the case where the apparatus 205 is to be locked, a locking operation in which the containment unit 210 transitions from an unlocked state to a locked state. Of course, a signal could also be transmitted by the electronic device 28 causing an unlocking operation in which the containment unit 210 transitions from a locked state to an unlocked state. Thus, the communication module 220 is operable with controller 232 so as to relay control signals/commands received from the electronic device 28. The electronic device 28 communicates with the communication module 220 using near field communication (NFC). Any other wireless protocol could also be used.

The controller 232 is configured for controlling or managing all operations of the apparatus 205 during use, independently or with input from the electronic device 28 of either first or second users. The controller 232 may comprise a processor which could include one or more cores that may enhance speed and performance of a multiprocessor. In some embodiments, the processor may be a dual core processor, quad core processors, other chip-level multiprocessor and the like that combine two or more independent cores.

The operations conducted by the electronic device 28 and the controller 232 (and/or indeed the electronic tag 22 of the apparatus 5) may be by way of an appropriate computing system including one or more computing devices. In particular, the methods and processes described herein may be implemented as a computer application, computer service, computer API, computer library, and/or other computer program product. Any such computing system could include a logic subsystem and a data-holding subsystem. The computing system may optionally include a display subsystem, communication subsystem, and/or other components. Such a computing system may also optionally include user input devices such as keyboards, mice, game controllers, cameras, microphones, and/or touch screens, for example. One or more logic subsystems may include one or more physical devices configured to execute one or more instructions. For example, any such logic subsystem may be configured to execute one or more instructions that are part of one or more applications, services, programs, routines, libraries, objects, components, data structures, or other logical constructs that could be operated by the electronic device 28 and or the controller 220 (and/or indeed the electronic tag 22 of the apparatus 5). Such instructions may be implemented to perform a task, implement a data type, transform the state of one or more devices, or otherwise arrive at a desired result.

The logic subsystem may include one or more processors that are configured to execute software instructions. Additionally or alternatively, the logic subsystem may include one or more hardware or firmware logic machines configured to execute hardware or firmware instructions. Processors of the logic subsystem may be single core or multicore, and the programs executed thereon may be configured for parallel or distributed processing. The logic subsystem may optionally include individual components that are distributed throughout two or more devices, which may be remotely located and/or configured for coordinated processing. One or more aspects of the logic subsystem may be virtualized and executed by remotely accessible networked computing devices configured in a cloud computing configuration.

The electronic device 28 and the controller 232 (and/or indeed the electronic tag 22 of the apparatus 5) may comprise various forms of data-holding systems for the storage of relevant and/or software instructions. Such data-holding systems (and/or related subsystems) may include one or more physical, non-transitory, devices configured to hold data and/or instructions executable by the logic subsystem to implement embodiments of the methods and processes described herein. When embodiments of the methods and/or processes described herein are implemented, the state of data-holding may be transformed (eg, to hold different data).

Data-holding subsystems may include removable media and/or built-in devices. Data-holding subsystems may include optical memory devices (e.g., CD, DVD, HD-DVD, Blu-Ray Disc, etc.), semiconductor memory devices (e.g., RAM, EPROM, EEPROM, etc.) and/or magnetic memory devices (e.g., hard disk drive, floppy disk drive, tape drive, MRAM, etc.), among others. Data-holding subsystems may include devices with one or more of the following characteristics: volatile, nonvolatile, dynamic, static, read/write, read-only, random access, sequential access, location addressable, file addressable, and content addressable. In some embodiments, logic subsystems and data-holding subsystems may be integrated into one or more common devices, such as an application specific integrated circuit or a system on a chip.

Software or program instructions operated by the electronic device 28, the controller 232, and/or the electronic tag 22 may be associated with a client that may include a file client, print client, domain client, internet client, intranet client and other variants such as secondary client, host client, distributed client and the like. The client may include one or more of memories, processors, computer readable media, storage media, ports (physical and virtual), communication devices, and interfaces capable of accessing other clients, servers, machines, and devices through a wired or a wireless medium, and the like. The methods, programs or codes as described herein and elsewhere may be executed by the client. In addition, other devices required for execution of methods as described in this application may be considered as a part of the infrastructure associated with the client. The client may provide an interface to other devices including, without limitation, servers, cloud servers, other clients, printers, database servers, print servers, file servers, communication servers, distributed servers and the like. Additionally, this coupling and/or connection may facilitate remote execution of one or more programs across the network. The networking of some or all of these devices may facilitate parallel processing of a program or method at one or more location without deviating from the scope of the disclosure. In addition, any of the devices attached to the client through an interface may include at least one storage medium capable of storing methods, programs, applications, code and/or instructions. A central repository may provide program instructions to be executed on different devices. In such implementations, remote repositories may act as a storage medium for program code, instructions, and programs.

### Second Example Method

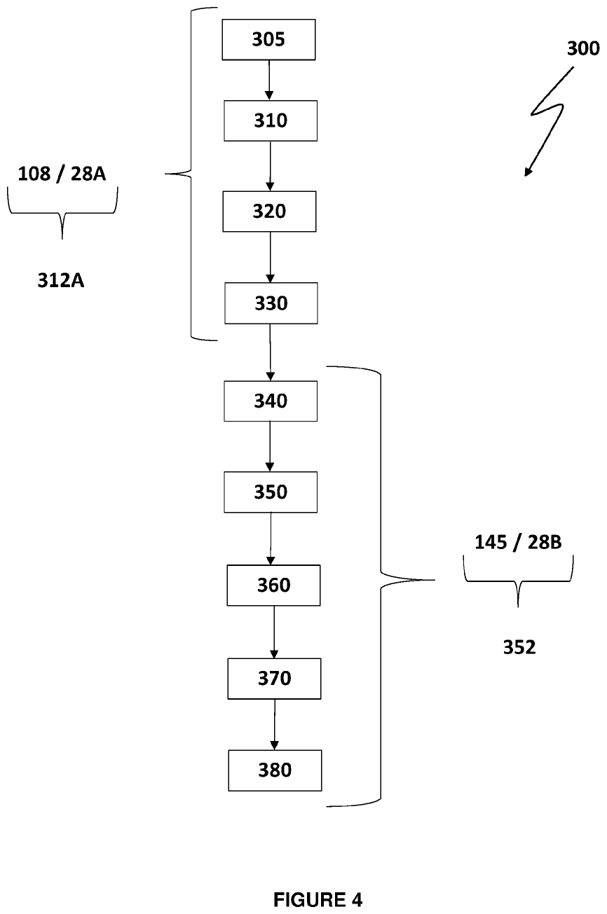

FIG. 4 shows a schematic flow chart of an embodiment of a method 300 for isolation locking of an asset using an embodiment of the apparatus 205. As described above, the apparatus 205 comprises a containment unit 210 configured for storing one or more keys 215 of an isolation lock for an asset.

Broadly, the method 300 comprises identifying 305 a relevant containment apparatus (205) associated with an asset that is to be isolated. The first user 108 ‘signs in’ 310 via their personal electronic device 28A which causes the opening of the relevant isolation permit related to the asset. A request is made by the first user 108 for the containment apparatus 205 to be placed in an unlocked state via their personal electronic device 28A once they have completed the ‘signing in’ process. If the containment apparatus 205 is in an unlocked state, the first user 108 will be permitted to admit 320 the relevant isolation key(s) 215 for storage. If the containment apparatus 205 is in a locked state, then all locking devices (electronic or otherwise (including virtual locks as described below)) will be requested to be removed by their respective users. Embodiments of methods facilitating unlocking of the containment apparatus (as described below), may be carried out in order to allow the containment apparatus 205 to transition to an unlocked state.

The operable device 230 comprises an electronic lock (230). In one form the electronic lock 230 is operable by controlling movement of a solenoid between an unlocked state and a locked state. The electronic lock 230 is configured so as to operate automatically to the locked state following expiry of a predetermined period of time (eg. 2 seconds in one implementation) commencing from when the closure 245 of the containment apparatus 205 is closed 330 by the first user 108. In this manner, once the period of time has expired, the electronic lock 230 transitions to a locked state thereby locking the containment apparatus 205 and securing the isolation key 215 therein.

Acknowledgement 340 that the containment apparatus 205 is in a first locked state by way of the first user 108 comprises the first user registering same via their personal electronic device 28A. The electronic device 28A then records or registers (via, for example, relevant software) that the containment apparatus 205 has been electronically locked by the first user 108. Once complete, the first user 108 sends a notification confirming that the containment apparatus 205 is in a locked state. Such notification may be directed to, for example, the first user's 108 superior who holds the appropriate authority regarding the asset. This signifies that an appropriately authorised second user such as worker 145 may now attend to registering a respective locked state in respect of the containment apparatus 205.

The worker 145 commences their part of the process by also ‘signing in’ (350) to their electronic device 28B in the same manner as described previous. This causes the relevant isolation permit to open on their electronic device 28B. As described above, the electronic device 28B operates to verify 360 that the worker 145 has the necessary authorisations to undertake work in respect of the asset.

The worker 145 then requests 370 via their electronic device 28B that the containment apparatus 205 be registered as locked in their favour. While the electronic lock 230 (by the first user 108) establishes the necessary physical lock of the containment apparatus 205, a second locked state sought by the worker 145 refers to a locking arrangement that is ‘virtual’ in nature, or not of a purely physical or tangible sense. In this regard, a virtual lock is, in one form, operably linked to the physical electronic lock but registered by way of appropriate software controls and registrations whereby the worker 145 requests that a locked state be registered on their behalf. In this manner, a record is created that associates a locked state of the containment apparatus 205 in favour of the worker 145. As a consequence of acceptance of the request 370 made by the worker 145, their personal electronic device 28B communicates with the containment apparatus 205 authorising 380 a locked state be registered in respect of the worker 145. Such communication may be facilitated by way of the communication module 220 associated with the containment apparatus 205.

At any stage where a locking action is performed, the first 108 or second 145 users may test, by physical means or by way of appropriate interrogations using their electronic device 28A/B, that the containment apparatus 205 is indeed locked (electronically or otherwise) and is secure.

The method 300 completes by notifying (via, for example, a message received via their electronic device 28B) the worker 145 that they are authorised to undertake the necessary actions or activities in respect of the asset.

It will be appreciated that the progress (or requisite prompts or instructions) of any stage of method 300 can be displayed to the first 108 second 145 via their electronic devices 28A/B.

### Example Method of Removing Isolation Locking of an Asset

A method for facilitating operational use of an asset that is subject to an isolation locking protocol can also be realised.

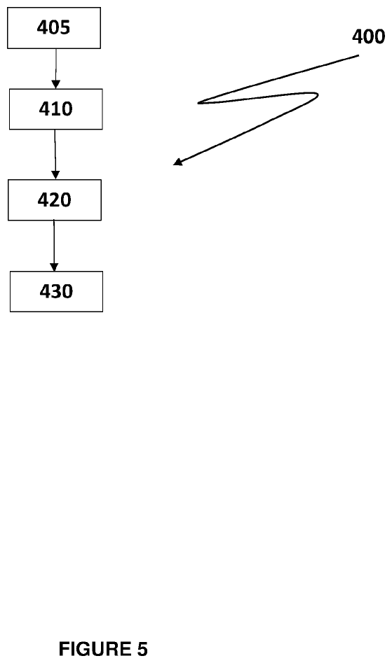

FIG. 5 shows a schematic flow chart of an embodiment of a method 400 for facilitating use of an asset subject to an isolation locking protocol, and the isolation keys (215) inaccessible by way of a containment apparatus, such as for example, apparatus 205. Broadly, the method 400 comprises identifying 405 the correct containment apparatus (205), requesting 410 one or more workers 145 each having a locked state registered in respect of the containment apparatus (205) each seek to have the locked states removed or deactivated as appropriate. Such request can be made by way of submitting a stored command (stored in their electronic device) specific to a worker to remove their electronic lock on the containment apparatus 205.

On determining 420 that all of the relevant operable means is/are in an inactive/unlocked state (ie. verifying that all electronic locks 230, physical, registered/virtual, or otherwise, have been removed), the method 400 involves authorising 430 a second user (generally in the form of user 108), who could have all the relevant and appropriate permissions of the Isolation Officer, to perform an action, which, when completed, permits access to the isolation key(s) held therein. Such an action is to operate (via a command via the Isolation Officer's electronic device an electronic lock to an unlock condition to which only the Isolation Officer has permission to operate. In this manner, the apparatus 205 is placed in an unlocked condition and the isolation key(s) can now be physically retrieved. The respective states of the locks (physical, electronic or virtual) may be tracked by use of a state machine executed on one or more electronic devices.

It will be appreciated that the progress (or requisite prompts or instructions) of any stage of method 400 can be displayed to users 108, 145 via their electronic devices 28A/B.

### Further Example

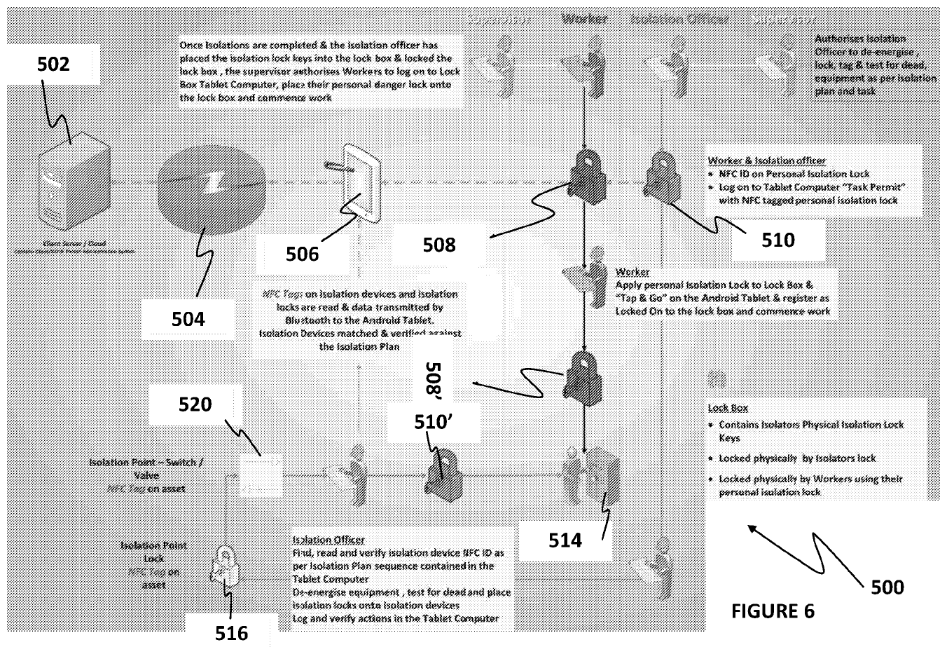

Referring to FIG. 6, a schematic example of a process 500 according to the present invention is described. In this process 500 there is a worksite supervisor, an isolation officer, and one or more workers. The isolation officer is responsible for isolation of the asset's power source. The isolation officer has a personal isolation lock, typically in the form of a padlock 510. Each worker that will be working on the asset will have their own personal danger lock, which may be in the form of a padlock 508. The asset has an isolation point 520, which may be a switch or valve. Typically, the isolation point 520 is locked with an isolation point lock 516, so as to physically prevent energising of the asset when it is installed on the isolation point 520. Each lock 508, 510 and 516 has an identifier on it, such as a NFC tag. The isolation point 520 also has an identifier, such as a NFC tag. There is also a server 502 connected via a network 504 to a portable computing device (PCD) 506, such as a smart phone, tablet, PDA etc.

When work is to be done on the asset by the workers, the supervisor authorises the isolation officer to deenergise, lock, tag and test for dead equipment as per an isolation plan and the work plan.

The isolation officer logs onto the respective PCD 506 and identifies the respective personal isolation lock 510 with the PCD 506. The PCD 506 logs this with the server 502 against the isolation plan. The server 502 records that the isolation officer has recorded the respective personal isolation lock 510 in relation to the isolation plan and the work task. The isolation plan is presented to the isolation officer on the PCD 506.

The isolation officer finds, reads and verifies the isolation device of the isolation point 520 as per the presented isolation plan. The identifier of the isolation point lock 516 is read by the PCD 506 and this is send to and recorded by the server 502. The asset is de-energised, tested for dead and the isolation lock 516 applied to the isolation point 520 so that the asset cannot be reenergised while the isolation lock 516 is in place. The identifier of the isolation point 520 is read by the PCD 506 and this is send to and recorded by the server 502. A log of the action is recorded in the by the PCD 506 and/or the server 502. The server 502 and/or the PCD 506 is able to match the identifier of the isolation lock 516 is applied to the isolation point 520 according to the isolation plan. If the incorrect lock is applied according to the isolation plan, or a lock not applied according to the isolation plan, then an alert is created. If there is more than one isolation point, each isolation lock 516 is applied and the respective keys taken.

The key(s) to the isolation lock(s) 516 is then placed in the isolation box 514. The isolation box 514 is locked with the scanned respective personal lock 510′ of the isolation officer. Thus, the key(s) is/are not able to be accessed when the lock 510′ is in place. The isolation officer scans the identifier of the isolation box 514 with their respective PCD 506 and this is send to and recorded by the server 502. A log of the action is recorded in the by the PCD 506 and/or the server 502. The isolation is now regarded as complete as per the details of the isolation plan.

The server 502 determines that the requirements for the isolation being complete are met (as defined above) and a notification is sent to the supervisor's PCD 506. The supervisor then authorises the worker(s) to commence their respective application of their danger locks 508 to the lock box 514 then to commence work according to the task plan.

Each worker uses their respective PCD 506 to scan the identifier of their personal danger lock 508 and this is send to and recorded by the server 502. Each worker applies their scanned personal danger lock 508′ to the lock box 514 and uses their respective PCD 506 to scan the identifier of the lock box 514. This is send to and recorded by the server 502. A log of the action is recorded in the by the respective worker's PCD 506 and/or the server 502. Typically, the when the personal danger lock 508 is a padlock the lock box 514 is unable to be opened while the padlock is in place. However as described above, the personal danger lock 508 may instead be a virtual lock applied to an electronic lock of the lock box 514.

The server 502 determines that the appropriate workers have applied their respective personal danger locks 508 to the lock box 514 according to the isolation plan and then indicates that the worker is safe to proceed. Alternatively, if there is a deviation from the isolation plan, the alerts server 502 the supervisor's PCD 506. And depending on a predetermined protocol the isolation officer's PCD 506 and/or one or more of the workers' PCDs 506.

The methods and/or processes described above, and steps thereof, may be realized in hardware, software, or any combination of hardware and software suitable for a particular application. The hardware may include a general purpose computer and/or dedicated computing device or specific computing device or particular aspect or component of a specific computing device. The methods/processes may be realised in one or more microprocessors, microcontrollers, embedded microcontrollers, programmable digital signal processors or other programmable device, along with internal and/or external memory. The methods/processes may also, or instead, be embodied in an application specific integrated circuit, a programmable gate array, programmable array logic, or any other device or combination of devices that may be configured to process electronic signals. It will further be appreciated that one or more of the methods/processes may be realised as a computer executable code capable of being executed on a machine readable medium.

Computer executable code may be created using a structured programming language such as C, an object oriented programming language such as C++, or any other high-level or low-level programming language (including assembly languages, hardware description languages, and database programming languages and technologies) that may be stored, compiled, or interpreted to run on any of the electronic devices, communication modules, or electronic tags, as well as heterogeneous combinations of processors, processor architectures, or combinations of different hardware and software, or any other machine capable of executing program instructions.

In, for example, one aspect, each method described above, and combinations thereof, may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device, or other hardware. In another aspect, the means for performing the steps associated with the processes described above may include any of the hardware and/or software described above. All such permutations and combinations are intended to fall within the scope of the present disclosure.

It is to be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of the above-described processes may be changed.

Future patent applications maybe filed in Australia or overseas on the basis of, or claiming priority from, the present application. It is to be understood that the following claims are provided by way of example only and are not intended to limit the scope of what may be claimed in any such future application. Features may be added to or omitted from the provisional claims at a later date so as to further define or re-define the invention or inventions.

1-49. (canceled)

50. An apparatus for use in isolation locking of an asset, the apparatus comprising:
a containment unit configured for storing one or more articles required for the operation of the asset, and configured so as to be capable of transitioning to a locked state by way of a plurality of operable devices each of which is able to be operated to lock the containment unit, and
an identifier of the containment unit, the identifier registered with a storage system and the identifier being in a form of a machine readable indicia acknowledgeable by a portable electronic device that reads the indicia as an identification of the containment unit.

51. The apparatus according to claim 50, wherein the containment unit comprises a storage receptacle comprising a volume within which the or each articles are held for storage purposes (temporary or otherwise).

52. The apparatus according to claim 50, wherein the apparatus comprises a plurality of electronic devices, wherein each electronic device is configured to read the indicia to determine the identifier and to send the determined identifier and an identification of the respective electronic device to the storage system.

53. The apparatus according to claim 52, wherein the storage system is configured to store an association between the respective portable electronic device and the identifier of the containment unit indicating an operable device associated with an assigned user of the respective portable electronic device has been applied to the containment unit.

54. The apparatus according to claim 53, wherein each portable electronic device is configured with software for providing an appropriate identification code to the electronic device which acknowledges the respective associated user.

55. The apparatus according to claim 54, wherein the software is configured to access the storage system to determine whether there is an association indicating the operable device of the user of the electronic device has been applied to the containment unit.

56. The apparatus according to claim 55, wherein the or each operable device is configured operable to facilitate a locking operation when applied or unlocking operation when removed in respect of the apparatus so as to place the apparatus in a locked or unlocked state, respectively.

57. The apparatus according to claim 56, wherein the software is configured to access the storage system to change the association to indicate the operable device of the user of the electronic device has been removed from the containment unit.

58. The apparatus according to claim 57, wherein the storage system is configured to store each association with the identification of the containment unit so as to track when the containment units is in a locked state with one or more operable devices associated therewith, or in an unlocked state with no operable devices associated wherewith.

59. The apparatus according to claim 50, wherein the identifier is in the form of a visual indicia or an electronic tag configured so as to identify the asset and/or apparatus when scanned or read by the electronic device.

60. The apparatus according to claim 50, wherein the storage receptacle comprises a lip portion located on the outside of the storage receptacle and arranged operable with a closure of the storage receptacle for the purposes of transitioning the containment unit to the unlocked or locked state.

61. A method for isolation locking of an asset, the method comprising:
identifying a containment apparatus associated with the asset by a first portable electronic device reading a machine readable indicia associated with the containment apparatus,
acknowledging a first user with the first portable electronic device,
admitting for containment by the containment apparatus one or more articles required for operation of the asset,
operating a first operable device associated with the first user to a state in which the containment apparatus is locked,
acknowledging that the containment apparatus is in a locked state by way of the first user with the first portable electronic device,
identifying the containment apparatus associated with the asset by a second portable electronic device reading the machine readable indicia associated with the containment apparatus,
acknowledging a second user with a second portable electronic device,
determining whether the second user has authorisation to undertake an action in respect of the asset,
if so authorised, operating the second operable device to a state in which the containment apparatus is locked, and
acknowledging that the containment apparatus is in a locked state by way of the second user thereby isolation locking the asset with the second portable electronic device.

62. The method according to claim 61, wherein the containment apparatus is an apparatus according to claim 50.

63. The method according to claim 61, comprising identifying the asset and verifying that the containment apparatus the electronic device is proximate to, is the correct containment apparatus for the identified asset.

64. The method according to claim 61, wherein acknowledgement of the first user is by way of the first user ‘signing in’ into the first electronic device using an identification code registered to the first user.

65. The method according to claim 61, wherein admitting for containment comprises placing the article required for the operation of the asset inside a storage receptacle of the containment apparatus.

66. The method according to claim 61, wherein the first and second operable devices are first and second locking devices respectively.

67. The method according to claim 66, wherein the first user scans an electronic tag provided on their respective locking device by way of their electronic device, this acknowledging that the first user has or will place the first locking device on the containment apparatus.

68. The method according to claim 67, wherein the first user then attends to locking the containment apparatus by way of their assigned physical locking device (such as for example, a padlock).

69. The method according to claim 66, wherein the first and second locking device comprise an identifier which corresponds to the first and second users respectively.

70. The method according to claim 66, wherein the second user scans an electronic tag provided on their respective locking device by way of the second electronic device, this acknowledging that the second user intends to or has placed their locking device on the containment apparatus.

71. The method according to claim 66, comprising acknowledging that the containment apparatus is in a locked state by way of the second user involves the second user acknowledging via the second electronic device that they have placed their locking device on the containment apparatus.

72. The method according to claim 61, wherein once the containment apparatus is locked, the method comprises acknowledging that the relevant isolation is complete.

73. The method according to claim 61, comprising authorising the second user to undertake an action in respect of the asset by way of the second user receiving a notification (message) on their electronic device.

74. An apparatus for use in isolation locking of an asset, the apparatus comprising:
a containment unit configured for storing one or more articles required for the operation of the asset,
a communication module configured to be capable of receiving a signal,
an identifier of the containment unit registered with a storage system and the identifier being in a form acknowledgeable by a portable electronic device,
a first operable device integrally associated with the containment unit and configured operable to transition the containment unit to a locked state in response to a lock command signal being received by the communication module,
a processor for tracking lock commands and unlock commands, received by the communication module, where the tracking cancels one of the lock commands when a corresponding unlock command is received, wherein the processor is configured to provide an unlock command signal to the first operable device when all lock commands received have been cancelled by corresponding unlock commands,
wherein the first operable device is configured to transition the containment unit to an unlocked state in response to the unlock command from the processor.

75. A method for isolation locking of an asset, the method comprising:
identifying a containment apparatus associated with the asset by a first portable electronic device, the containment apparatus configured operable between unlocked and locked states by way of, at least in part, an operable device of the containment apparatus,
acknowledging a first user with the first portable electronic device,
admitting for containment by the containment apparatus one or more articles required for operation of the asset when the containment apparatus is in an unlocked state,
operating the operable device so as to provide the containment apparatus in a locked state,
acknowledging that the containment apparatus is in a first locked state by way of the first user with the first portable electronic device,
acknowledging a second user with a second portable electronic device,
determining whether the second user has authorisation to undertake an action in respect of the asset,
if so authorised, registering a request to associate a second locked state of the containment apparatus by the second user, and
if so accepted, registering the second locked state of the containment apparatus thereby isolation locking the asset.
